(19) United States
(12) Patent Application Publication
(10) Pub. No.: US 2025/0262987 A1
(43) Pub. Date: Aug. 21, 2025

(54) BIOLOGICAL SIGNAL DETECTION APPARATUS AND BIOLOGICAL SIGNAL DETECTION METHOD

(71) Applicant: Panasonic Automotive Systems Co., Ltd., Kanagawa (JP)

(72) Inventor: Ryutaro SENO, Kanagawa (JP)

(21) Appl. No.: 19/049,640

(22) Filed: Feb. 10, 2025

(30) Foreign Application Priority Data
Feb. 16, 2024 (JP) 2024-022157

(51) Int. Cl. B60N 2/00

(52) U.S. Cl. CPC B60N 2/0023; B60N 2/0022; B60N 2210/20

(57) ABSTRACT

One aspect of a biological signal detection apparatus of the present disclosure includes an antenna circuitry which, in operation, performs sweeping emission of an electromagnetic wave toward an occupant of a vehicle and receives a reflected wave of the electromagnetic wave, and a module circuitry which, in operation, detects a biological signal of the occupant based on the reflected wave, in which the antenna circuitry and the module circuitry are configured to dispose in a buckle of a seat belt of a seat disposed in the vehicle.

### CROSS REFERENCE TO RELATED APPLICATIONS

The disclosure of Japanese Patent Application No. 2024-022157 filed on Feb. 16, 2024 including the specification, drawings and abstract is incorporated herein by reference in its entirety.

### TECHNICAL FIELD

The present disclosure relates to a biological signal detection apparatus and a biological signal detection method.

### BACKGROUND ART

In recent years, traffic accidents caused by factors such as drowsy driving, decreased concentration due to drowsiness, and poor physical condition of vehicle drivers have become a social issue. For this reason, systems have been developed that estimate the driver's alertness or poor physical condition by detecting driver's biological signals and can take actions such as awakening the driver, encouraging a break, or initiating an emergency call or emergency stop if it is determined that the driver is in a state that may interfere with driving.

For example, PTL 1 discloses a radar for detecting the pulse or the like of a seated person, which is disposed within a seat back not to give a sense of foreign matter to the seated person.

### CITATION LIST

### Patent Literature

PTL 1

WO2021/065526

### SUMMARY OF INVENTION

### Technical Problem

However, in the technology disclosed in PTL 1, the radar for detecting a biological signal is built into the seat back and is covered around it, resulting in a problem with heat dissipation property. Further, the technology disclosed in PTL 1 has a problem in that the radar is not easily detachable during repair or replacement, resulting in poor maintainability.

The present disclosure has been made in view of the above circumstances, and contributes to providing a biological signal detection apparatus and a biological signal detection method that are excellent in heat dissipation property and maintainability.

### Solution to Problem

One aspect of a biological signal detection apparatus of the present disclosure includes: an antenna circuitry which, in operation, performs sweeping emission of an electromagnetic wave toward an occupant of a vehicle and receives a reflected wave of the electromagnetic wave; and a module circuitry which, in operation, detects a biological signal of the occupant based on the reflected wave, in which the antenna circuitry and the module circuitry are configured to dispose in a buckle of a seat belt of a seat disposed in the vehicle.

One aspect of a biological signal detection method of the present disclosure includes: performing sweeping emission of an electromagnetic wave toward an occupant of a vehicle by an antenna circuitry is configured to dispose in a buckle of a seat belt of a seat disposed in the vehicle; receiving, by the antenna circuitry, a reflected wave of the electromagnetic wave; and detecting a biological signal of the occupant based on the reflected wave by a module circuitry is configured to dispose in the buckle.

### Advantageous Effects of Invention

According to the present disclosure, it is possible to provide a biological signal detection apparatus and a biological signal detection method that are excellent in heat dissipation property and maintainability.

### BRIEF DESCRIPTION OF DRAWINGS

FIG. 1 is a view illustrating an example of the inside of a vehicle to which a biological signal detection apparatus of the present embodiment is applied;

FIG. 2 is an enlarged view schematically illustrating an example of a buckle shown in FIG. 1;

FIG. 3 is a perspective view schematically illustrating an example of the buckle in which the biological signal detection apparatus is illustrated in a perspective manner;

FIG. 4 is a block diagram illustrating an exemplary configuration of the biological signal detection apparatus according to the present embodiment;

FIG. 5 is a diagram illustrating an example of a sweeping emission direction of an electromagnetic wave by the biological signal detection apparatus according to the present embodiment;

FIG. 6 is a diagram illustrating an example of a posture of an occupant leaning against a backrest of a seat;

FIG. 7 is a diagram illustrating an example of a posture of an occupant who is raising his/her body from the backrest of the seat;

FIG. 8 is a diagram illustrating an example of the sweeping emission direction of electromagnetic waves by the biological signal detection apparatus in Variation 1;

FIG. 9 is a diagram illustrating an example of the sweeping emission direction of electromagnetic waves by the biological signal detection apparatus in Variation 2;

FIG. 10 is a diagram illustrating an example of switching the sweeping emission direction of electromagnetic waves by the biological signal detection apparatus in Variation 3;

FIG. 11 is a diagram illustrating an example of switching the sweeping emission direction of electromagnetic waves by the biological signal detection apparatus in Variation 3;

FIG. 12 is a perspective view schematically illustrating an example of a buckle in which the biological signal detection apparatus of Variation 4 is illustrated in a perspective manner;

FIG. 13 is a plan view of the yz plane schematically illustrating an example of the buckle in Variation 4;

FIG. 14 is a plan view of a yz plane schematically illustrating an example of a buckle in Variation 5;

FIG. 15 is a circuit diagram illustrating an example of the electrical connection of the biological signal detection apparatus in Variation 6;

FIG. 16 is a block diagram illustrating an exemplary configuration of the biological signal detection apparatus and a vehicle ECU in Variation 7; and

FIG. 17 is a flowchart illustrating an example of processing performed by the biological signal detection apparatus and the vehicle ECU in Variation 7.

### DESCRIPTION OF EMBODIMENTS

Hereinafter, embodiments of the present disclosure (hereinafter, simply referred to as “the present embodiment”) will be described in detail with reference to the drawings. Note that the present disclosure is not limited to the following embodiments. Further, the following embodiments and variations can be combined as appropriate.

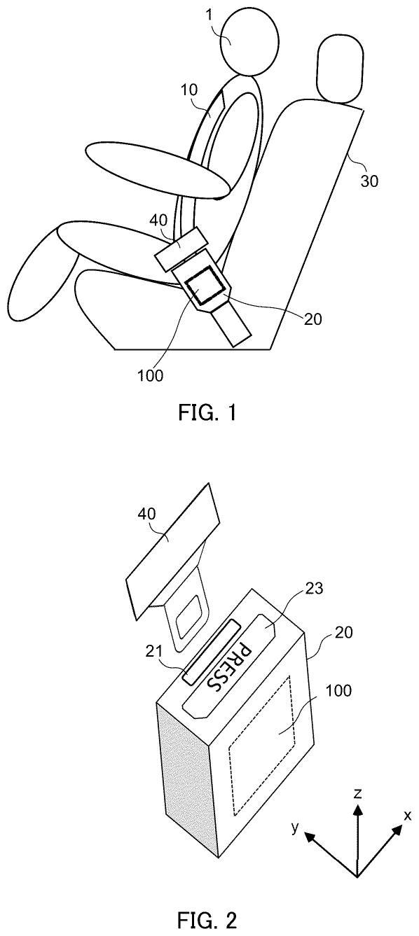

FIG. 1 is a view illustrating an example of the inside of a vehicle to which biological signal detection apparatus 100 of the present embodiment is applied. Biological signal detection apparatus 100 detects biological signals such as the heartbeat and respiration of occupant 1 in the vehicle such as an automobile. Occupant 1 may be either the driver or a passenger. As illustrated in FIG. 1, biological signal detection apparatus 100 of the present embodiment is disposed in buckle 20 of seat belt 10 disposed in the vehicle. Occupant 1 is seated in seat 30 with seat belt 10 worn. Seat belt 10 restrains the upper body and the waist of occupant 1 seated in seat 30. Note that, occupant 1 wears seat belt 10 by inserting tongue plate 40 attached to seat belt 10 into buckle 20. Buckle 20 is disposed beside seat 30.

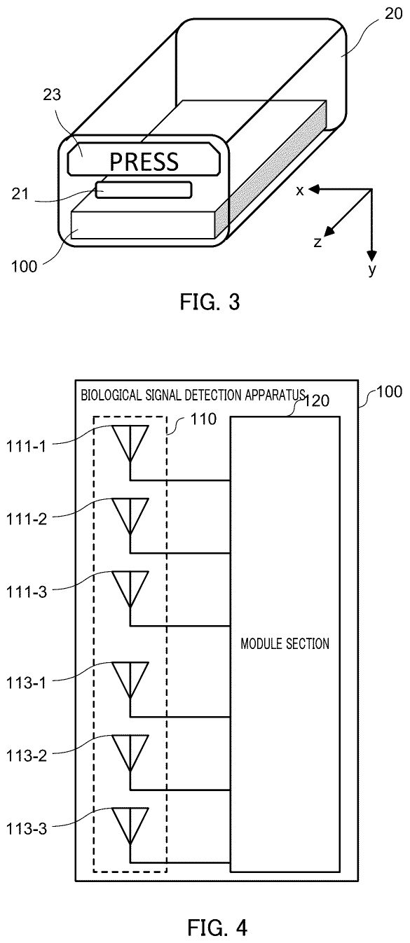

FIG. 2 is an enlarged view schematically illustrating an example of buckle 20 illustrated in FIG. 1. FIG. 3 is a perspective view schematically illustrating an example of buckle 20 in which biological signal detection apparatus 100 is illustrated in a perspective manner. Buckle 20 is formed with insertion opening 21. Insertion opening 21 is an opening into which tongue plate 40 is inserted, and locks tongue plate 40 inserted therein. Further, buckle 20 is provided with PRESS button 23. PRESS button 23 is a button for releasing the lock of tongue plate 40 inserted into insertion opening 21 and releasing tongue plate 40 from insertion opening 21.

Further, buckle 20 incorporates biological signal detection apparatus 100 of the present embodiment. In the present embodiment, biological signal detection apparatus 100 will be described using the case where biological signal detection apparatus 100 is disposed at a position closer to seat 30 or occupant 1 (positive y-direction) in buckle 20. Note that the position in which biological signal detection apparatus 100 is incorporated is not limited to this, and biological signal detection apparatus 100 may be disposed at a position away from seat 30 or occupant 1 in buckle 20 (in the negative y-direction).

In the present embodiment, biological signal detection apparatus 100 performs sweeping emission of electromagnetic waves toward occupant 1 in a vehicle and detects the biological signal of occupant 1 based on the reflected waves of the electromagnetic waves. In the present embodiment, an example will be described in which biological signal detection apparatus 100 is a millimeter-wave radar module capable of measuring respiration, heartbeat, and the like of a living body in a non-contact manner by sweeping emission of millimeter waves. Note that the present disclosure is not limited thereto, and biological signal detection apparatus 100 may be, for example, a radar module (sensor module) capable of detecting a biological signal by sweeping emission of an electromagnetic wave in another frequency band such as a microwave.

FIG. 4 is a block diagram illustrating an exemplary configuration of biological signal detection apparatus 100 according to the present embodiment. As illustrated in FIG. 4, biological signal detection apparatus 100 includes antenna section 110 and module section 120. Antenna section 110 and module section 120 are included in biological signal detection apparatus 100, and thus are disposed in buckle 20.

Antenna section 110 performs sweeping emission of electromagnetic waves toward occupant 1 and receives the reflected waves of the electromagnetic waves. In the present embodiment, antenna section 110 performs sweeping emission of electromagnetic waves from a surface of biological signal detection apparatus 100 facing seat 30 (surface in the positive y-direction). For example, antenna section 110 will perform sweeping emission of electromagnetic waves from the surface of buckle 20 that faces seat 30 (the surface of buckle 20 in the positive y-direction). Antenna section 110 can be realized, for example, by a broadside array antenna.

Antenna section 110 includes antenna elements 111-1 to 111-3 of a transmission antenna and antenna elements 113-1 to 113-3 of a reception antenna. Note that, in the following description, when antenna elements 111-1 to 111-3 of the transmission antenna are not distinguished from each other, they may be simply referred to as antenna elements 111. Similarly, in a case where antenna elements 113-1 to 113-3 of the reception antenna are not distinguished from each other, they may be simply referred to as antenna elements 113. In the example illustrated in FIG. 4, a case is exemplified where there are three antenna elements 111 of the transmission antenna and three antenna elements 113 of the reception antenna, respectively. Note that the numbers of antenna elements are not limited to this, and may be any other combination.

Each of antenna elements 111 of the transmission antenna performs sweeping emission of an electromagnetic wave toward occupant 1. Each of antenna elements 113 of the reception antenna receives a reflected wave of the electromagnetic wave emitted toward occupant 1 in a sweeping manner and reflected back by occupant 1. As described above, antenna section 110 of the present embodiment is realized by a broadside array antenna. For this reason, in the present embodiment, antenna elements 111 of the transmission antenna and antenna elements 113 of the reception antenna are arrayed in the surface of biological signal detection apparatus 100 facing seat 30 (a surface in the positive y-direction).

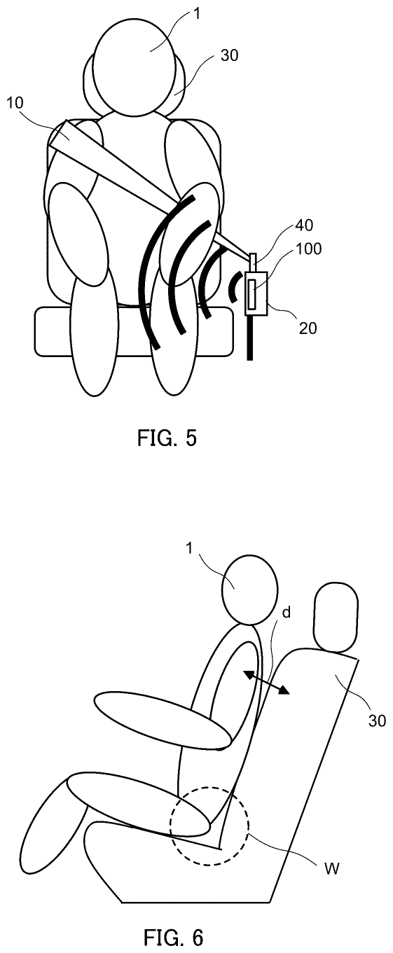

Module section 120 controls antenna section 110 (each antenna element 111 of the transmission antenna) such that electromagnetic waves are emitted toward occupant 1 in a sweeping manner. FIG. 5 is a diagram illustrating an example of the sweeping emission direction of the electromagnetic wave by biological signal detection apparatus 100 of the present embodiment. In the present embodiment, module section 120 controls each antenna element 111 of the transmission antenna such that biological signal detection apparatus 100 performs sweeping emission of electromagnetic waves toward the vicinity of the waist of occupant 1, as illustrated in FIG. 5. Specifically, module section 120 controls each antenna element 111 of the transmission antenna such that biological signal detection apparatus 100 performs sweeping emission of electromagnetic waves toward the vicinity of the waist of occupant 1 from the position and posture of buckle 20 assumed when occupant 1 wears seat belt 10. Further, module section 120 detects the biological signal of occupant 1 based on the reflected wave received by antenna section 110 (each antenna element 113 of the reception antenna).

A main component of module section 120 is a well-known microcomputer including, for example, a central processing unit (CPU), a read only memory (ROM), and a random access memory (RAM), and module section 120 includes an oscillator, a signal processing circuit that performs transmission and reception processing, and the like. Note that a part of module section 120 may be realized by a dedicated hardware circuit that does not include a CPU or the like.

Further, for example, a part of the processing of module section 120 may be executed by an external apparatus such as a vehicle electronic control unit (ECU). For example, module section 120 may estimate the biological state of occupant 1 based on the detected biological signal of occupant 1, or may output the detected biological signal of occupant 1 to the vehicle ECU, and the vehicle ECU may perform this estimation process. Examples of the estimation of the biological state include, but are not limited to, the estimation of the alertness of occupant 1 (driver) and the estimation of a poor physical condition.

As described above, in the present embodiment unlike the related art, biological signal detection apparatus 100 is disposed in buckle 20 of seat belt 10, and the surroundings of a radar for detecting a biological signal are not covered with a seat or the like. For this reason, according to the present embodiment, it is possible to provide biological signal detection apparatus 100 with excellent heat dissipation property.

When a radar for detecting a biological signal is installed in a seat as in the related art, the seat is more likely to be affected by heat when the seat is equipped with a seat heater, and the influence of heat dissipation property becomes more serious. To address this issue, also in a case where seat 30 is equipped with a seat heater, it is possible to provide biological signal detection apparatus 100 that is less susceptible to the influence of heat and has excellent heat dissipation properties according to the present embodiment. In an electric vehicle (EV), it is difficult to utilize the waste heat from the engine, and there is a tendency to rely on a seat heater rather than an air conditioner for the heating function in order to improve the electricity efficiency. Therefore, the advantage of biological signal detection apparatus 100 of the present embodiment increases.

Further, in the present embodiment unlike the related art, biological signal detection apparatus 100 is disposed in buckle 20 of seat belt 10, and the surroundings of a radar for detecting a biological signal are not covered with a seat or the like. For this reason, according to the present embodiment, it is possible to provide biological signal detection apparatus 100 with excellent maintainability, since attachment and detachment are easy during repair or replacement of biological signal detection apparatus 100. Further, if buckle 20 is replaced as a whole during the repair or replacement of biological signal detection apparatus 100, the maintainability is further increased.

Further, in the present embodiment, since biological signal detection apparatus 100 performs sweeping emission of the electromagnetic wave toward the vicinity of the waist of occupant 1, whose position and posture are unlikely to change, it is possible to enhance the detection accuracy of the biological signal. Further, in the present embodiment, it is possible to prevent the detection accuracy of the biological signal from deteriorating due to a change in the position or posture of occupant 1, and thus, in a case where the biological state of occupant 1 is estimated based on the biological signal, it is possible to stably estimate the biological information.

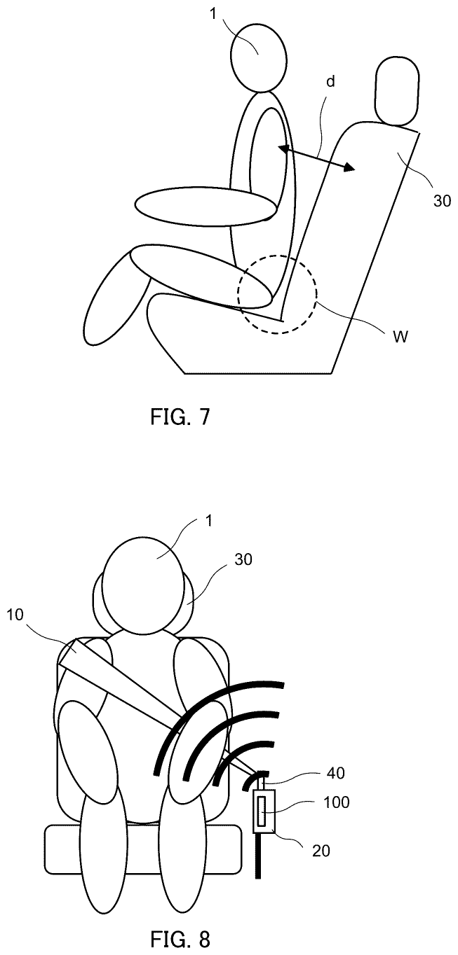

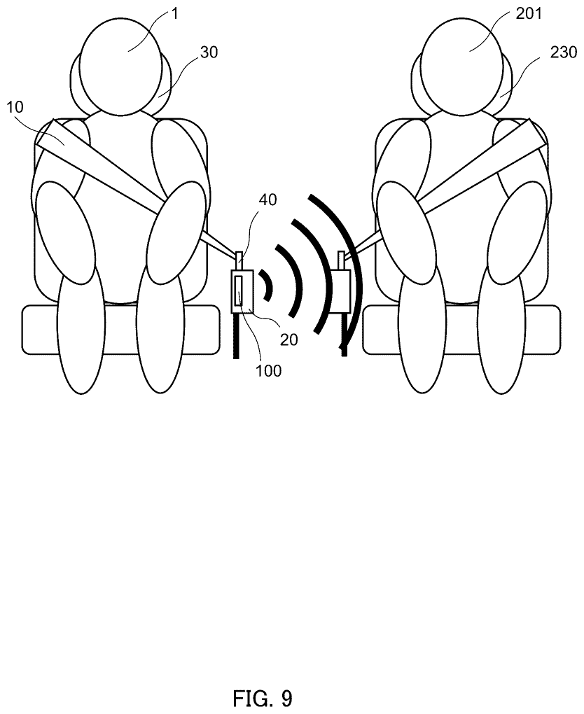

FIGS. 6 and 7 are diagrams for describing a posture change of occupant 1 seated in seat 30. FIG. 6 is a view illustrating an example of the posture of occupant 1 who is leaning against the backrest of seat 30. FIG. 7 is a view illustrating an example of a posture of occupant 1 who has raised his/her body from the backrest of seat 30. As is apparent from the change in distance d in FIGS. 6 and 7, the position and posture of the upper body of occupant 1 change depending on whether occupant 1 is leaning against the backrest of seat 30 or has raised his/her body. Note that distance d indicates the distance between the back of occupant 1 and the backrest portion of seat 30. On the other hand, since the vicinity of the waist of occupant 1 is fixed with a lap belt (not illustrated) of seat belt 10, the position and posture are unlikely to change even when occupant 1 leans against the backrest of seat 30 or raises his/her body, as illustrated in region W in FIGS. 6 and 7.

For example, the position near the waist when seated in seat 30 is less likely to depend on the physique, such as age (adult or child). Further, buckle 20 is difficult to move in the left-right direction (vehicle width direction) due to its structure, and the position of the occupant's waist is also difficult to move in the left-right direction (vehicle width direction). For this reason, the distance between the waist of occupant 1 and biological signal detection apparatus 100 is unlikely to vary. Thus, according to the present embodiment, it is possible to enhance the detection accuracy of a biological signal without depending on the physique of occupant 1.

In a case where a radar for detecting a biological signal is built into a seat back as in the related art, the distance between the radar and the occupant changes depending on the posture of the occupant, and thus, the detection accuracy of the biological signal may deteriorate, and it may be difficult to stably estimate the biological information.

### Variation 1

In Variation 1, an example in which biological signal detection apparatus 100 performs sweeping emission of electromagnetic waves toward the upper body of occupant 1 will be described.

In Variation 1, antenna section 110 performs sweeping emission of electromagnetic waves from the upper surface (surface in the positive z-direction) of biological signal detection apparatus 100. For example, antenna section 110 will perform sweeping emission of electromagnetic waves from the surface of buckle 20 into which tongue plate 40 is inserted (the surface of buckle 20 in the positive z-direction). Antenna section 110 can be realized, for example, by an end-fire array antenna.

In Variation 1, antenna elements 111 of the transmission antenna and antenna elements 113 of the reception antenna are, for example, arrayed on the zx plane of biological signal detection apparatus 100.

FIG. 8 is a diagram illustrating an example of the sweeping emission direction of the electromagnetic wave by biological signal detection apparatus 100 of Variation 1. In Variation 1, module section 120 controls each antenna element 111 of the transmission antenna such that biological signal detection apparatus 100 performs sweeping emission of electromagnetic waves toward the upper body of occupant 1, as illustrated in FIG. 8. Specifically, module section 120 controls each antenna element 111 of the transmission antenna such that biological signal detection apparatus 100 performs sweeping emission of electromagnetic waves toward the upper body of occupant 1 from the position and posture of buckle 20 assumed when occupant 1 wears seat belt 10.

As described above, according to Variation 1, it is possible to reduce the thickness of biological signal detection apparatus 100 and to suppress the increase in the thickness of buckle 20 as a result of sweeping emission of electromagnetic waves with an end-fire array antenna.

### Variation 2

In Variation 2, an example in which biological signal detection apparatus 100 performs sweeping emission of electromagnetic waves toward occupant 201 located next to occupant 1 will be described.

FIG. 9 is a diagram illustrating an example of the sweeping emission direction of the electromagnetic wave by biological signal detection apparatus 100 of Variation 2. In Variation 2, as illustrated in FIG. 9, seat 230 is positioned adjacent to seat 30 with buckle 20 interposed therebetween, and occupant 201 is seated in seat 230. In Variation 2, antenna section 110 performs sweeping emission of electromagnetic waves toward occupant 201 and receives the reflected waves of the electromagnetic waves. For this reason, in Variation 2, antenna section 110 performs sweeping emission of electromagnetic waves from the surface of biological signal detection apparatus 100 opposite to seat 30 (the surface in the negative y-direction). For example, antenna section 110 will perform sweeping emission of electromagnetic waves from the surface of buckle 20 in the direction opposite to seat 30 (the surface of buckle 20 in the negative y-direction). Antenna section 110 can be realized, for example, by a broadside array antenna. For example, the surface of buckle 20 in the direction opposite to seat 30 is the surface of buckle 20 in the direction facing seat 230.

Note that, biological signal detection apparatus 100 of Variation 2 may be configured to perform sweeping emission of electromagnetic waves in the direction of seat 30, as described in the embodiment, in addition to the direction of seat 230. In this case, antenna section 110 may be disposed on both surfaces of biological signal detection apparatus 100, and sweeping emission of the electromagnetic wave may be performed while switching antenna section 110 that is to perform sweeping emission.

According to Variation 2, biological signal detection apparatus 100 can perform sweeping emission of electromagnetic waves in both directions, and thus can detect a biological signal of occupant 201, who is another occupant. For this reason, according to Variation 2, it is possible to detect the biological signals of all occupants in the vehicle without providing biological signal detection apparatus 100 in all buckles of the vehicle, and the number of biological signal detection apparatuses 100 to be installed can be reduced.

### Variation 3

In Variation 3, an example in which biological signal detection apparatus 100 performs sweeping emission of electromagnetic waves while switching the sweeping emission direction will be described.

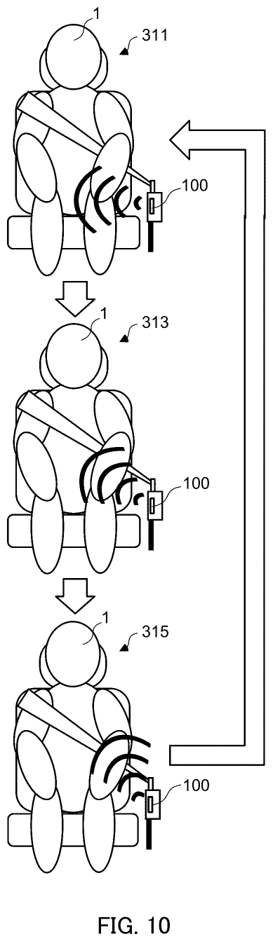

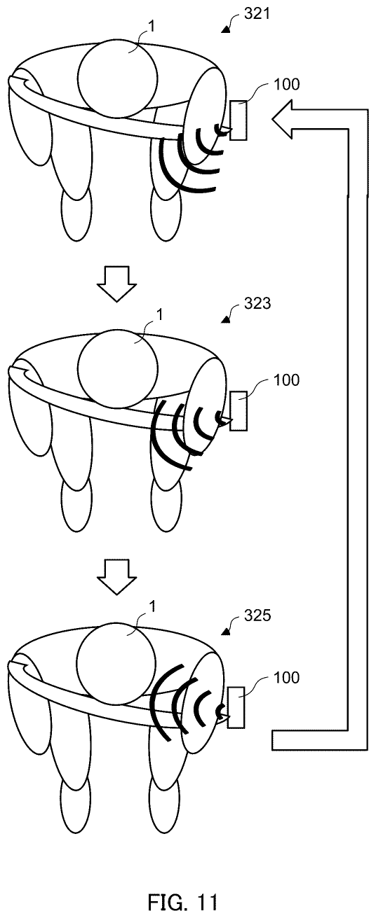

In Variation 3, module section 120 controls antenna section 110 (each antenna element 111 of the transmission antenna) to perform sweeping emission of the electromagnetic wave while switching the sweeping emission direction toward occupant 1. FIGS. 10 and 11 are views illustrating an example of switching the sweeping emission direction of the electromagnetic wave by biological signal detection apparatus 100 of Variation 3. As illustrated in FIGS. 10 and 11, antenna section 110 performs sweeping emission of electromagnetic waves while switching the sweeping emission direction.

FIG. 10 illustrates an example of switching the sweeping emission direction of the electromagnetic wave as viewed from the yz plane. In the example illustrated in FIG. 10, antenna section 110 (each antenna element 111 of the transmission antenna) switches the sweeping emission direction and performs sweeping emission of the electromagnetic wave while looping through state 311, state 313, state 315, state 311, . . . in this order. In state 311, antenna section 110 is performing sweeping emission of electromagnetic waves toward a lower region of the seat back. In state 313, antenna section 110 is performing sweeping emission of electromagnetic waves toward the central region of the seat back. In state 315, antenna section 110 is performing sweeping emission of electromagnetic waves toward the upper region of the seat back.

FIG. 11 illustrates an example of switching the sweeping emission direction of the electromagnetic wave as viewed from the xy plane. In the example illustrated in FIG. 11, antenna section 110 (each antenna element 111 of the transmission antenna) switches the sweeping emission direction and performs sweeping emission of the electromagnetic wave while looping in the order of state 321, state 323, state 325, state 321, . . . In state 321, antenna section 110 is performing sweeping emission of electromagnetic waves toward the front of the thigh of occupant 1 (near the knee). In state 323, antenna section 110 is performing sweeping emission of electromagnetic waves toward the middle of the thigh of occupant 1. In state 325, antenna section 110 is performing sweeping emission of electromagnetic waves toward the rear of the thigh of occupant 1 (waist portion).

In Variation 3, module section 120 controls each antenna element 111 of the transmission antenna to perform sweeping emission of the electromagnetic wave, as illustrated in FIGS. 10 and 11, for example. Note that the example of switching the sweeping emission direction of the electromagnetic wave is not limited to the examples in FIGS. 10 and 11, and for example, the sweeping emission direction of the electromagnetic wave may be switched by combining the switching in FIGS. 10 and 11. Module section 120 switches the sweeping emission direction of the electromagnetic wave using, for example, a technology such as beamforming.

In Variation 3, module section 120 controls the direction of the electromagnetic wave to be transmitted to the outside by electronic scanning. Module section 120 continuously generates a transmission signal of a high frequency (for example, a millimeter wave frequency band) by performing frequency modulation processing such that the frequency repeats a gradual increase and a gradual decrease temporally, using a reference signal acquired from the oscillator, for example. Module section 120 transmits the transmission signal generated for each antenna element 111 to this antenna element 111, and causes each antenna element 111 to transmit an electromagnetic wave that is frequency-modulated. Note that, module section 120 changes the direction of the electromagnetic wave to be transmitted to the outside (for example, a synthesized wave of the electromagnetic waves to be transmitted from each antenna element 111) by adjusting the phase of the electromagnetic wave to be transmitted from each antenna element 111.

Further, in Variation 3, module section 120 detects a signal based on the reflected wave received for each sweeping emission direction, and considers a signal in which the phase variation of the signal detected satisfies a predetermined condition as a biological signal. Specifically, module section 120 considers the signal with the highest reliability as the biological signal. For example, module section 120 determines that the signal with the largest variation is a signal reflected from the human body, and considers it as a biological signal.

According to Variation 3, a plurality of signals is acquired while switching the sweeping emission direction, and the signal with the highest reliability among the acquired signals is used as the biological signal, thereby enabling the biological signal to be detected with high accuracy. For this reason, the biological state can also be estimated with high accuracy.

### Variation 4

In Variation 4, an example in which antenna section 110 includes an antenna pattern formed of a conductive film will be described.

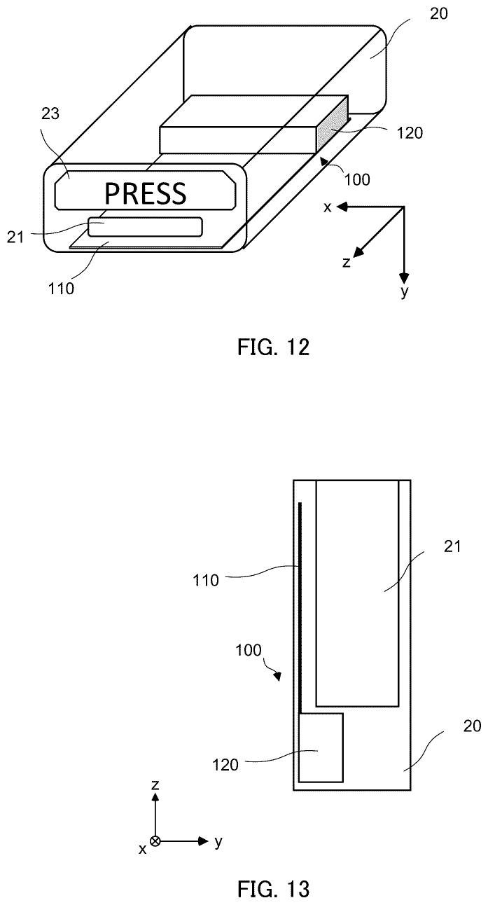

FIG. 12 is a perspective view schematically illustrating an example of buckle 20 in which biological signal detection apparatus 100 in Variation 4 is illustrated in a perspective manner. FIG. 13 is a plan view of the yz plane schematically illustrating an example of buckle 20 in Variation 4. As illustrated in FIGS. 12 and 13, antenna section 110 (each antenna element 111 of the transmission antenna and each antenna element 113 of the reception antenna) is constituted by an antenna pattern formed of a conductive film (metasurface). The conductive film may be a transparent electrode.

Thus, according to Variation 4, the thickness of antenna section 110 can be reduced, and thus, the thickness of buckle 20 can be reduced. Further, biological signal detection apparatus 100 can be disposed in buckle 20 without impairing the function of seat belt 10.

### Variation 5

In Variation 5, an example in which antenna section 110 is disposed on the outside (surface) of buckle 20 in Variation 4 will be described.

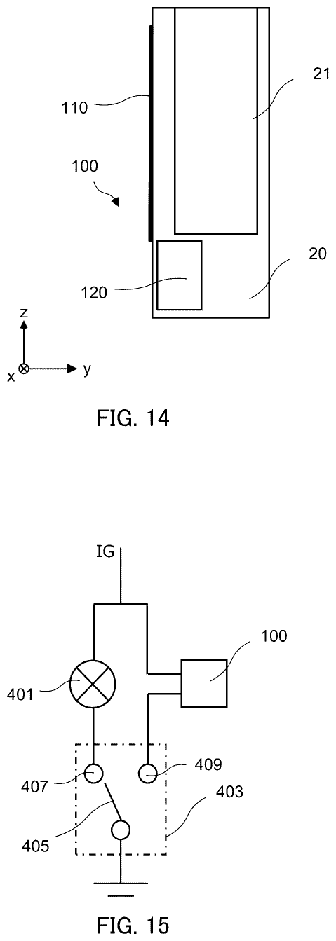

FIG. 14 is a plan view of the yz plane schematically illustrating an example of buckle 20 in Variation 5. As illustrated in FIG. 14, antenna section 110, which is constituted by an antenna pattern formed of a conductive film (metasurface), is disposed on the outer peripheral surface of buckle 20.

Thus, according to Variation 5, the thickness of antenna section 110 can be reduced, and thus, the thickness of buckle 20 can be reduced. Further, biological signal detection apparatus 100 can be disposed in buckle 20 without impairing the function of seat belt 10. For example, in Variation 5, since antenna section 110 is installed outside the housing of buckle 20, it is possible to avoid changing the shape of existing buckle 20 or to minimize the change. Further, in Variation 5, biological signal detection apparatus 100 can be disposed in buckle 20 even in a case where the housing of buckle 20 is made of a material that does not transmit radio waves.

(Variation 6)

In Variation 6, an example in which biological signal detection apparatus 100 is activated when occupant 1 wears seat belt 10 will be described.

FIG. 15 is a circuit diagram illustrating an example of the electrical connection of biological signal detection apparatus 100 in Variation 6. In the example illustrated in FIG. 15, an ignition power source (IG power source), biological signal detection apparatus 100, and warning light 401 are electrically connected, and the power source can be switched on and off by seat belt switch 403.

In Variation 6, when tongue plate 40 is not inserted into buckle 20 and switch 405 of seat belt switch 403 is connected to terminal 407 in a state where the IG power source is in the on state, warning light 401 is turned on. Thus, it is possible to notify the occupant of forgetting to wear seat belt 10.

Further, in Variation 6, when tongue plate 40 is inserted into buckle 20 and switch 405 of seat belt switch 403 is connected to terminal 409 in a state where the IG power source is turned on, power is supplied to biological signal detection apparatus 100, and biological signal detection apparatus 100 (antenna section 110 and module section 120) activates.

As described above, in Variation 6, based on the fact that occupant 1 is seated in seat 30 in a state where the vehicle is capable of traveling, biological signal detection apparatus 100 (antenna section 110 and module section 120) activates. More specifically, based on the insertion of tongue plate 40 into buckle 20, biological signal detection apparatus 100 (antenna section 110 and module section 120) is activated.

For this reason, according to Variation 6, in a case where occupant 1 does not wear seat belt 10, biological signal detection apparatus 100 is not activated, thus it is possible to reduce the load on the battery.

Note that, in Variation 6, even when the IG power source is off, power may be supplied separately to biological signal detection apparatus 100 to activate biological signal detection apparatus 100. Thus, even in a case where a child is left inside the vehicle, it is possible to detect that the child is left inside the vehicle.

In this case, for example, a timer (for example, 3 minutes) is set when the IG power source is turned off, and during this time, biological signal detection apparatus 100 is activated with an increased sweeping emission period of the electromagnetic wave. Then, the power of biological signal detection apparatus 100 may be turned off after the time set by the timer has elapsed. In this manner, even in a case where a child is left inside the vehicle, the load on the battery can be reduced, and it is possible to detect that the child is left.

### Variation 7

In Variation 7, an example of using a biological state estimated by biological signal detection apparatus 100 will be described.

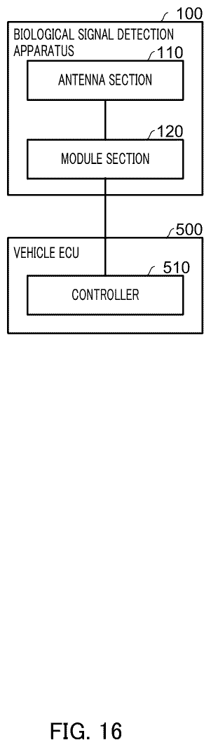

FIG. 16 is a block diagram illustrating an exemplary configuration of biological signal detection apparatus 100 and vehicle ECU 500 in Variation 7. Since biological signal detection apparatus 100 is the same as in the embodiment, a description thereof will be omitted. Vehicle ECU 500 includes controller 510. Controller 510 receives the biological state from biological signal detection apparatus 100 and performs control to prevent a vehicle accident based on the received biological state. For example, controller 510 determines that the received biological state indicates a decrease in the driver's alertness or a poor physical condition, which would interfere with driving. In this case, controller 510 awakens the driver, encourages the driver to take a break, issues a warning, makes an emergency call, or causes an emergency stop. Note that, as described above, the estimation of the biological state may be performed by vehicle ECU 500 instead of biological signal detection apparatus 100.

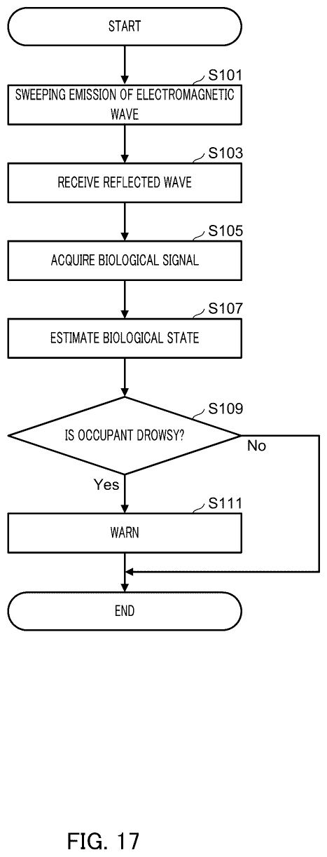

FIG. 17 is a flowchart illustrating an example of processing performed by biological signal detection apparatus 100 and vehicle ECU 500 in Variation 7.

To begin with, antenna section 110 performs sweeping emission of electromagnetic waves toward occupant 1 (step S101) and receives the reflected waves of the electromagnetic waves (step S103).

Subsequently, module section 120 acquires the biological signal of occupant 1 based on the reflected wave received by antenna section 110 (step S105).

Subsequently, module section 120 estimates the biological state of occupant 1 based on the acquired biological signal of occupant 1 (step S107).

Subsequently, controller 510 receives the biological state of occupant 1 from biological signal detection apparatus 100 and determines whether occupant 1 is drowsy (step S109).

In a case where occupant 1 is drowsy (Yes in step S109), controller 510 awakens the driver, encourages the driver to take a break, or issues a warning (step S111). In a case where occupant 1 is not drowsy (No in step S109), controller 510 does not issue a warning.

As described above, according to the above embodiment and each of the above variations, it is possible to provide a biological signal detection apparatus and a biological signal detection method that are excellent in heat dissipation property and maintainability.

Note that the above-described embodiments and each of the above-described variations are merely examples of specific embodiments for carrying out the present disclosure, and the technical scope of the present disclosure is not interpreted in a limited manner by these embodiments and variations. For example, the present disclosure can be implemented in various forms without departing from the spirit or essential characteristics thereof. For example, the above-described embodiment and each of the above-described variations may be appropriately combined with each other in each configuration unit. Further, for example, in the above-described embodiment and each of the above-described variations, some components may be deleted from all the components.

In the above descriptions, the expression “section” used for the components may be replaced with another expression such as “assembly,” “circuit (circuitry),” “device,” “unit,” or “module.” The apparatus may be configured to be performed by CPU using program accumulated in a memory.

The present disclosure includes the following aspects.
(1) A biological signal detection apparatus, including: an antenna section that performs sweeping emission of an electromagnetic wave toward an occupant of a vehicle and receives a reflected wave of the electromagnetic wave; and
a module section that detects a biological signal of the occupant based on the reflected wave, in which
the antenna section and the module section are disposed in a buckle of a seat belt of a seat disposed in the vehicle.

(2) The biological signal detection apparatus according to above (1), in which
the antenna section performs sweeping emission of the electromagnetic wave in a direction facing the seat.

(3) The biological signal detection apparatus according to above (1), in which
the antenna section performs sweeping emission of the electromagnetic wave in a direction opposite to a direction in which a tongue plate of the seat belt is inserted into the buckle.

(4) The biological signal detection apparatus according to above (3), in which
the antenna section includes an end-fire array antenna.

(5) The biological signal detection apparatus according to above (1), in which
the antenna section performs sweeping emission of the electromagnetic wave in a direction opposite to the seat.

(6) The biological signal detection apparatus according to above (1), in which
the antenna section is disposed in the buckle at a position closer to the seat disposed in the vehicle than an insertion opening of a tongue plate of the seat belt is to the seat.

(7) The biological signal detection apparatus according to above (1), in which
the antenna section switches one sweeping emission direction with another and performs sweeping emission of the electromagnetic wave, and
the module section detects a signal for each of the sweeping emission directions, and considers that a signal in which a phase variation of the signal detected satisfies a condition is the biological signal.

(8) The biological signal detection apparatus according to above (1), in which
the antenna section includes an antenna pattern formed of a conductive film.

(9) The biological signal detection apparatus according to above (8), in which
the antenna section is disposed outside the buckle.

(10) The biological signal detection apparatus according to above (1), in which
the antenna section and the module section are activated after the occupant is seated in the seat.

(11) The biological signal detection apparatus according to above (1), in which
the antenna section and the module section are activated after a tongue plate is inserted into the buckle.

(12) The biological signal detection apparatus according to above (1), in which
the module section estimates a biological state of the occupant based on the biological signal.

(13) A biological signal detection method, comprising:
performing sweeping emission of an electromagnetic wave toward an occupant of a vehicle by an antenna section disposed in a buckle of a seat belt of a seat disposed in the vehicle;
receiving, by the antenna section, a reflected wave of the electromagnetic wave; and
detecting a biological signal of the occupant based on the reflected wave by a module section disposed in the buckle.

(14) The biological signal detection method according to above (13), in which
the sweeping emission of the electromagnetic wave is performed in a direction facing the seat.

(15) The biological signal detection method according to above (13), in which
the sweeping emission of the electromagnetic wave is performed in a direction opposite to a direction in which a tongue plate of the buckle is inserted.

(16) The biological signal detection method according to above (13), in which
the sweeping emission of the electromagnetic wave is performed in a direction opposite to the seat.

(17) The biological signal detection method according to above (13), in which:
the sweeping emission of the electromagnetic wave is performed while switching one sweeping emission direction with another, and
out of signals detected by the module section respectively in the sweeping emission directions, a signal in which a phase variation of the signal detected satisfies a condition is considered as the biological signal.

(18) The biological signal detection method according to above (13), in which
the antenna section and the module section are activated after the occupant is seated in the seat.

(19) The biological signal detection method according to above (13), in which
the antenna section and the module section are activated after a tongue plate is inserted into the buckle.

(20) The biological signal detection method according to above (13), further comprising:
estimating, by the module section, a biological state of the occupant based on the biological signal.

### REFERENCE SIGNS LIST

1 Occupant
10 Seat belt
20 Buckle
30 Seat
40 Tongue plate
100 Biological signal detection apparatus
110 Antenna section
120 Module section
111, 111-1 to 111-3 Antenna element
113, 113-1 to 113-3 Antenna element
500 Vehicle ECU
510 Controller

1. A biological signal detection apparatus, comprising:
an antenna circuitry which, in operation, performs sweeping emission of an electromagnetic wave toward an occupant of a vehicle and receives a reflected wave of the electromagnetic wave; and
a module circuitry which, in operation, detects a biological signal of the occupant based on the reflected wave, wherein
the antenna circuitry and the module circuitry are configured to dispose in a buckle of a seat belt of a seat disposed in the vehicle.

2. The biological signal detection apparatus according to claim 1, wherein
the antenna circuitry which, in operation, performs sweeping emission of the electromagnetic wave in a direction facing the seat.

3. The biological signal detection apparatus according to claim 1, wherein
the antenna circuitry which, in operation, performs sweeping emission of the electromagnetic wave in a direction opposite to a direction in which a tongue plate of the seat belt is inserted into the buckle.

4. The biological signal detection apparatus according to claim 3, wherein
the antenna circuitry includes an end-fire array antenna.

5. The biological signal detection apparatus according to claim 1, wherein
the antenna circuitry which, in operation, performs sweeping emission of the electromagnetic wave in a direction opposite to the seat.

6. The biological signal detection apparatus according to claim 1, wherein
the antenna circuitry is configured to dispose in the buckle at a position closer to the seat disposed in the vehicle than an insertion opening of a tongue plate of the seat belt is to the seat.

7. The biological signal detection apparatus according to claim 1, wherein:
the antenna circuitry which, in operation, switches one sweeping emission direction with another and performs sweeping emission of the electromagnetic wave, and
the module circuitry which, in operation, detects a signal for each of the sweeping emission directions, and considers that a signal in which a phase variation of the signal detected satisfies a condition is the biological signal.

8. The biological signal detection apparatus according to claim 1, wherein
the antenna circuitry includes an antenna pattern formed of a conductive film.

9. The biological signal detection apparatus according to claim 8, wherein
the antenna circuitry is configured to dispose outside the buckle.

10. The biological signal detection apparatus according to claim 1, wherein
the antenna circuitry and the module circuitry are activated after the occupant is seated in the seat.

11. The biological signal detection apparatus according to claim 1, wherein
the antenna circuitry and the module circuitry are activated after a tongue plate is inserted into the buckle.

12. The biological signal detection apparatus according to claim 1, wherein
the module circuitry which, in operation, estimates a biological state of the occupant based on the biological signal.

13. A biological signal detection method, comprising:
performing sweeping emission of an electromagnetic wave toward an occupant of a vehicle by an antenna circuitry is configured to dispose in a buckle of a seat belt of a seat disposed in the vehicle;
receiving, by the antenna circuitry, a reflected wave of the electromagnetic wave; and
detecting a biological signal of the occupant based on the reflected wave by a module circuitry is configured to dispose in the buckle.

14. The biological signal detection method according to claim 13, wherein
the sweeping emission of the electromagnetic wave is performed in a direction facing the seat.

15. The biological signal detection method according to claim 13, wherein
the sweeping emission of the electromagnetic wave is performed in a direction opposite to a direction in which a tongue plate of the buckle is inserted.

16. The biological signal detection method according to claim 13, wherein
the sweeping emission of the electromagnetic wave is performed in a direction opposite to the seat.

17. The biological signal detection method according to claim 13, wherein:
the sweeping emission of the electromagnetic wave is performed while switching one sweeping emission direction with another, and
out of signals detected by the module circuitry respectively in the sweeping emission directions, a signal in which a phase variation of the signal detected satisfies a condition is considered as the biological signal.

18. The biological signal detection method according to claim 13, wherein
the antenna circuitry and the module circuitry are activated after the occupant is seated in the seat.

19. The biological signal detection method according to claim 13, wherein
the antenna circuitry and the module circuitry are activated after a tongue plate is inserted into the buckle.

20. The biological signal detection method according to claim 13, further comprising:
estimating, by the module circuitry, a biological state of the occupant based on the biological signal.
